(19) United States
(12) Patent Application Publication
(10) Pub. No.: US 2024/0034035 A1
(43) Pub. Date: Feb. 1, 2024

(54) MULTI-LAYERED POLYMER SHEET AND METHOD OF FORMING THE SAME AND BRACE

(71) Applicant: Taiwan Busway Co., Ltd., Taoyuan City (TW)

(72) Inventor: Min-Li CHEN, Taoyuan (TW)

(21) Appl. No.: 18/065,704

(22) Filed: Dec. 14, 2022

(30) Foreign Application Priority Data
Jul. 29, 2022 (TW) 111128489

(51) Int. Cl. B32B 27/30; B32B 27/32; B32B 27/40; A61C 7/00

(52) U.S. Cl. CPC B32B 27/308; B32B 27/32; B32B 27/40; A61C 7/00; B32B 2307/51; B32B 2310/0831; B32B 2274/00; B32B 2250/04; B32B 2250/246; B32B 2255/10; B32B 2307/732

(57) ABSTRACT

Multi-layered polymer sheets include a first hard polymer film with an elastic modulus of 1000 MPa to 2500 MPa, and a first soft polymer film with an elastic modulus of 100 MPa to 1000 MPa disposed on the first hard polymer film. The elastic modulus of the first hard polymer film is greater than that of the first soft polymer film by at least 500 MPa. The first hard polymer film includes a thermoplastic polymer, and the first soft polymer film includes a thermoset polymer.

### CROSS REFERENCE TO RELATED APPLICATIONS

The present application is based on, and claims priority from, Taiwan application Serial Number 111128489, filed on Jul. 29, 2022, the disclosure of which is hereby incorporated by reference herein in its entirety.

### TECHNICAL FIELD

The technical field relates to a multi-layered polymer sheet, and in particular it relates to the composition and method of forming the multi-layered polymer.

### BACKGROUND

The goal of orthodontic treatment is to move a patient's teeth into optimized functional and/or aesthetical positions. Traditionally, braces are applied to a patient's teeth by an orthodontist, and the braces may apply a constant force (e.g. stress) to the teeth and gradually push them toward the intended positions. After a series of clinical examination and responsive adjustments to the braces over time, the braces can move the teeth into their final positions.

During different stages of the orthodontic treatment, braces of different stiffness are generally required. In general, at least 50 sets of braces are required during two years of orthodontic treatment, which needs multi-layered polymer sheets of at least 20 stiffness values to achieve the correct orthodontic effect. However, commercially available multi-layered polymer sheets are formed by a hot-melt, single-layered (or multi-layered), extrusion mass production process, making the braces difficult to customize (e.g. small quantity and large variety production). In other words, the customer (i.e. the orthodontist) can only select those multi-layered, polymer sheets of existing specifications that are commercially available, and cannot order multi-layered polymer sheets of different specifications that may batter meet the needs of their patients.

Therefore, a novel multi-layered polymer sheet is called-for to meet the requirement of customization.

### SUMMARY

One embodiment of the disclosure provides a multi-layered polymer sheet that includes a first hard polymer film and a first soft polymer film. The first hard polymer film has an elastic modulus of 1000 MPa to 2500 MPa. The first soft polymer film has an elastic modulus of 100 MPa to 1000 MPa. The first soft polymer film is disposed on the first hard polymer film. The elastic modulus of the first hard polymer film is greater than that of the first soft polymer film by at least 500 MPa. The first hard polymer film includes a thermoplastic polymer. The first soft polymer film includes a thermoset polymer.

In some embodiments, the multi-layered polymer sheet has a thickness of 0.5 mm to 1.0 mm, the first hard polymer film has a thickness of 0.3 mm to 0.8 mm, and the first soft polymer film has a thickness of 0.1 mm to 0.4 mm.

In some embodiments, the multi-layered polymer sheet further includes a second hard polymer film, wherein the first soft polymer film is disposed between the first hard polymer film and the second hard polymer film, and the thickness and the composition of the first hard polymer film are substantially the same as those of the second hard polymer film.

In some embodiments, the multi-layered polymer sheet has a thickness of 0.5 mm to 1.0 mm, the first hard polymer film and the second hard polymer film have a total thickness of 0.4 mm to 0.9 mm, and the first soft polymer film has a thickness of 0.01 mm to 0.4 mm.

In some embodiments, the multi-layered polymer sheet further includes a second soft polymer film, wherein the first hard polymer film is disposed between the first soft polymer film and the second soft polymer film, and the thickness and the composition of the first soft polymer film are substantially the same as that of the second soft polymer film.

In some embodiments, the multi-layered polymer sheet has a thickness of 0.5 mm to 1.0 mm, the first hard polymer film has a thickness of 0.4 mm to 0.8 mm, and the first soft polymer film and the second soft polymer film have a total thickness of 0.1 mm to 0.4 mm.

In some embodiments, the thermoplastic polymer includes polyester, polycarbonate, polyurethane, polyamide, polyolefin, polyether ether ketone, polyether sulfone, or a copolymer thereof.

In some embodiments, the thermoset polymer is made of a UV curable coating that is cured by UV radiation, and the UV curable coating includes a photo initiator, an acrylate oligomer, and an acrylate monomer.

In some embodiments, the acrylate oligomer includes aliphatic polyurethane diacrylate oligomer, aromatic polyurethane diacrylate oligomer, aliphatic polyurethane multi-acrylate oligomer, aromatic polyurethane multi-acrylate oligomer, or a combination thereof. The acrylate monomer includes aliphatic tri-functional methacrylate, bisphenol A epoxy acrylate, aliphatic trifunctional acrylate, urethane dimethacrylate, or a combination thereof.

In some embodiments, the multi-layered polymer sheet has an elastic modulus of 800 MPa to 2000 MPa.

In some embodiments, the multi-layered polymer sheet has a damping factor (tan δ) of 0.01 to 0.18.

One embodiment of the disclosure provides a brace formed from the previously described multi-layered polymer sheet.

One embodiment of the disclosure provides a method of forming a multi-layered polymer sheet. The method includes providing a first hard polymer film with an elastic modulus of 1000 MPa to 2500 MPa. The method includes coating a UV curable coating on the first surface of the first hard polymer film. The method includes exposing the UV curable coating to UV radiation, which cures the UV curable coating and thereby forms a first soft polymer film on the first surface of the first hard polymer film. The first soft polymer film has an elastic modulus of 100 MPa to 1000 MPa. The elastic modulus of the first hard polymer film is greater than that of the first soft polymer film by at least 500 MPa. The first hard polymer film includes a thermoplastic polymer. The first soft polymer film includes a thermoset polymer. The UV curable coating includes a photo initiator, an acrylate oligomer, and an acrylate monomer.

In some embodiments, the acrylate oligomer includes aliphatic polyurethane diacrylate oligomer, aromatic polyurethane diacrylate oligomer, aliphatic polyurethane multi-acrylate oligomer, aromatic polyurethane multi-acrylate oligomer, or a combination thereof. The acrylate monomer includes aliphatic tri-functional methacrylate, bisphenol A epoxy acrylate, aliphatic trifunctional acrylate, urethane dimethacrylate, or a combination thereof.

In some embodiments, the method further includes attaching a second hard polymer film onto the UV curable coating after coating the UV curable coating on the first surface of the first hard polymer film and before curing the UV curable coating, and then exposing the UV curable coating to UV radiation to cure the UV curable coating. This forms the first soft polymer film between the first hard polymer film and the second hard polymer film. The composition of the first hard polymer film is substantially the same as that of the second hard polymer film.

In some embodiments, the method further includes coating another UV curable coating on a second surface of the first hard polymer film after forming the first soft polymer film on the first surface of the first hard polymer film. The second surface of the first hard polymer film is opposite the first surface of the first hard polymer film. The method further includes exposing the other UV curable coating to UV radiation to cure the other UV curable coating. This forms a second soft polymer film on the second surface of the first hard polymer film. The composition of the first soft polymer film is substantially the same as that of the second soft polymer film.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows a method of manufacturing a multi-layered polymer sheet in one embodiment of the disclosure.

FIG. 2 shows a method of manufacturing a multi-layered polymer sheet in one embodiment of the disclosure.

FIG. 3 shows a method of manufacturing a multi-layered polymer sheet in one embodiment of the disclosure.

FIG. 4 shows a simulation result of section stiffness of the multi-layered polymer sheet corresponding to the hard polymer film of different thicknesses in one embodiment of the disclosure.

FIG. 5 shows a simulation result of section stiffness of the multi-layered polymer sheet corresponding to the hard polymer film of different thicknesses in one embodiment of the disclosure.

FIG. 6 shows a simulation result of section stiffness of the multi-layered polymer sheet corresponding to the hard polymer film of different thicknesses in one embodiment of the disclosure.

FIG. 7 shows a photograph of the teeth before being straightened in one embodiment of the disclosure.

FIG. 8 shows a photograph of the teeth after being straightened in one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

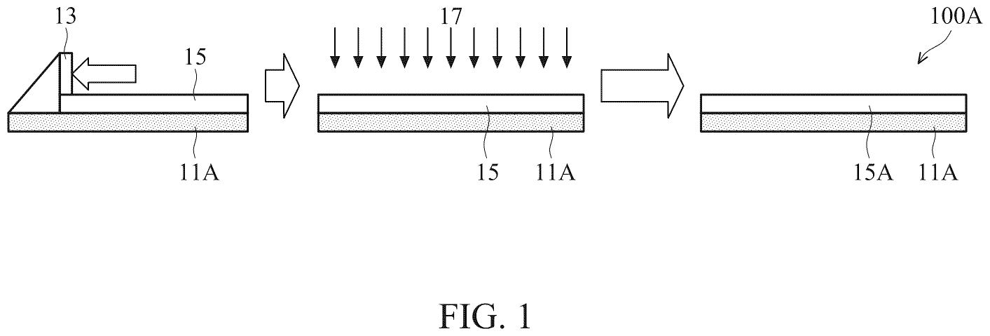

One embodiment of the disclosure provides a method of forming a multi-layered polymer sheet, as shown in FIG. 1. First, a first hard polymer film 11A with an elastic modulus of 1000 MPa to 2500 MPa is provided. If the elastic modulus of the hard polymer film 11A is too low, the force applied to the teeth will be too small and the orthodontic effect will be poor. If the elastic modulus of the hard polymer film 11A is too high, the force applied to the teeth will be too large, the orthodontic patient will be uncomfortable and the teeth necrosis may occur. In some embodiments, the first hard polymer film 11A includes thermoplastic polymer such as polyester, polycarbonate, polyurethane, polyamide, polyolefin, polyether ether ketone, polyether sulfone, a copolymer thereof, or another suitable material. For example, the suitable polyester for the first hard polymer film 11A can be PETG (copolymerized from terephthalic acid, cyclohexanedimethanol, and ethylene glycol) or PET (polyethylene terephthalate).

Subsequently, a UV curable coating 15 is coated on a first surface of the first hard polymer film 11A. In some embodiments, the coating can be coated by a blade 13 (e.g. blade coating) to accurately control the thickness of the UV curable coating 15. Alternatively, the UV curable coating 15 can be coated by any other method such as dipping coating, spray coating, spin-on coating, or another suitable method, as long as the thickness of the UV curable coating 15 can be controlled.

In some embodiments, the UV curable coating includes a photo initiator, an acrylate oligomer, and an acrylate monomer. In addition, an auxiliary agent such as adhesive promoter, leveling agent, or another auxiliary agent can be optionally added. After the photo initiator being exposed to UV radiation, the acrylate oligomer and the acrylate monomer will crosslink to form a film. In some embodiments, the acrylate oligomer includes aliphatic polyurethane diacrylate oligomer, aromatic polyurethane diacrylate oligomer, aliphatic polyurethane multi-acrylate oligomer, aromatic polyurethane multi-acrylate oligomer, or a combination thereof. Accordingly, the acrylate oligomer includes two or more (e.g. up to ten) acrylate groups to be beneficial for the crosslink reaction. In some embodiments, the acrylate monomer includes aliphatic tri-functional methacrylate, bisphenol A epoxy acrylate, aliphatic trifunctional acrylate, urethane dimethacrylate, or a combination thereof. The acrylate monomer also includes two or more acrylate groups to be beneficial for the crosslink reaction. In some embodiments, the acrylate oligomer and the acrylate monomer may have a weight ratio of 1:0.1 to 1:0.5. If the acrylate oligomer amount is too low, the elasticity and strength of the cured coating will be insufficient. If the acrylate oligomer amount is too high, the coating liquid will be too viscous to be coated and processed.

Subsequently, the UV curable coating 15 is exposed to UV radiation 17 to be cured, thereby forming a first soft polymer film 15A on the first surface of the first hard polymer film 11A. A multi-layered (e.g. two-layered) polymer sheet 100A has been completed so far. The UV radiation may cause the compositions in the UV curable coating 15 crosslink to cure. In some embodiments, the cured first soft polymer film 15A has an elastic modulus of 500 MPa to 1000 MPa. If the elastic modulus of the first soft polymer film 15A is too low, the elastic modulus of the multi-layered polymer sheet 100A will be too low, and it may apply an overly less force to the teeth and result in a poor orthodontic effect. If the elastic modulus of the first soft polymer film 15A is too high, the comfort of the orthodontic patient will be reduced.

In some embodiments, the elastic modulus of the first hard polymer film 11A is greater than that of the first soft polymer film 1A by at least 500 MPa. If the difference is too small, the enhancement of the damping factor of the multi-layered polymer sheet will be too small, and the comfort of the orthodontic patient will be reduced.

As described above, the first soft oligomer film 15A includes the thermoset polymer. Because the first soft polymer film 15A is directly cured on the first surface of the first hard polymer film 11A, there is an excellent adhesion therebetween without additional adhesive agent. Note that the embodiments of the disclosure does not attach the thermoset polymer film to the thermoplastic polymer film, because the attachment often needs an adhesive agent, which may degrade the physical properties of the multi-layered polymer sheet and increase the thickness of the multi-layered polymer sheet. If the thermoset polymer film is attached to the thermoplastic film by a thermal process, the process will be complex and the cost will be dramatically increased.

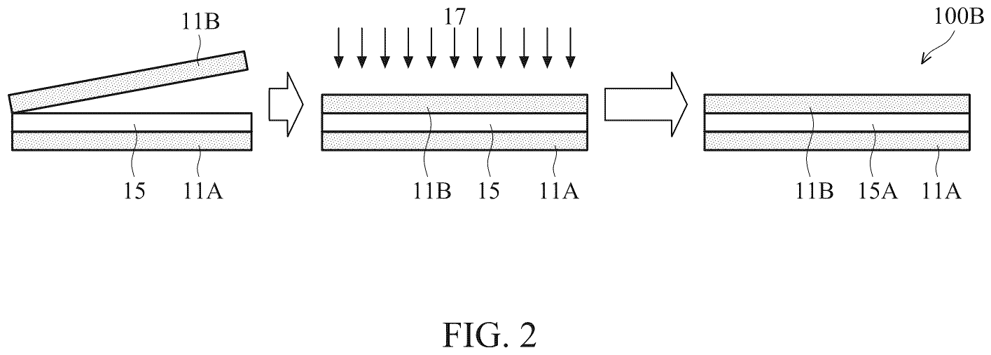

In some embodiments, the method further includes attaching a second hard polymer film 11B onto the UV curable coating 15 after coating the UV curable coating 15 on the first surface of the first hard polymer film 11A and before curing the UV curable coating 15, and then exposing the UV curable coating 15 to UV radiation 17 to cure the UV curable coating 15, thereby forming the first soft polymer film 15A between the first hard polymer film 11A and the second hard polymer film 11B, as shown in FIG. 2. In some embodiments, the composition of the first hard polymer film 11A is substantially the same as that of the second hard polymer film 11B. In some embodiments, the thickness of the first hard film 11A is substantially the same as that of the second hard polymer film 11B. Alternatively, the composition and/or the thickness of the first hard polymer film 11A can be different from that of the second hard polymer film 11B (e.g. an asymmetrical structure).

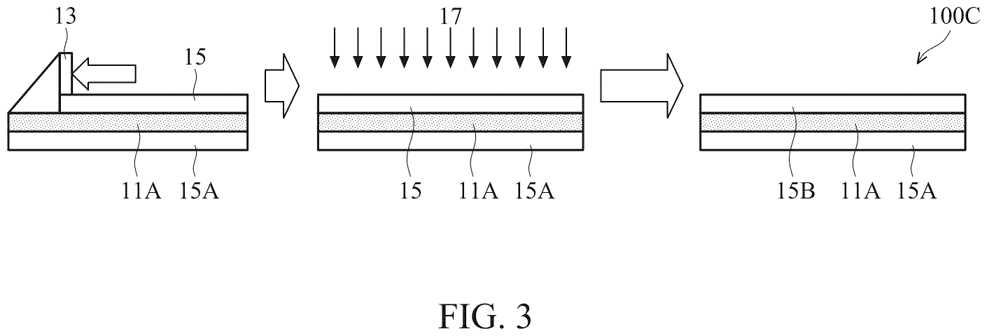

In some embodiments, the method further includes coating another UV curable coating 15 on a second surface of the first hard polymer film 11A after forming the first soft polymer film 15A on the first surface of the first hard polymer film 11A, and the second surface of the first hard polymer film 11A is opposite the first surface of the first hard polymer film 11A. The method of coating the other UV curable coating 15 is described above, and the related description is not repeated here. The other UV curable coating 15 is then exposed by the UV radiation 17 to cure the other UV curable coating 15, thereby forming a second soft polymer film 15B on the second surface of the first hard polymer film 11A, thereby obtaining a multi-layered polymer sheet 100C, as shown in FIG. 3. In this embodiment, the first hard polymer film 11A is disposed between the first soft polymer film 15A and the second soft polymer film 15B. In some embodiments, the composition of the first soft polymer film 15A is substantially the same as that of the second soft polymer film 15B. In some embodiments, the thickness of the first soft film 15A is substantially the same as that of the second soft polymer film 15B. Alternatively, the composition and/or the thickness of the first soft polymer film 15A can be different from that of the second soft polymer film 15B (e.g. an asymmetrical structure).

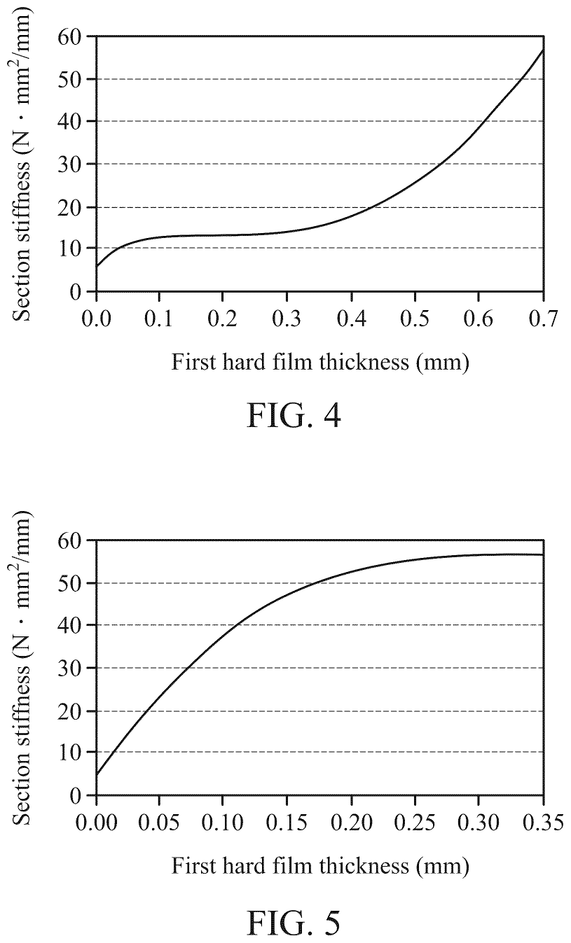

In some embodiments as shown in FIG. 1, the multi-layered polymer sheet 100A has a thickness of 0.5 mm to 1.0 mm, the first hard polymer film 11A has a thickness of 0.3 mm to 0.8 mm, and the first soft polymer film 15A has a thickness of 0.1 mm to 0.4 mm. For example, the multi-layered polymer sheet 100A has a total thickness of 0.7 mm, and a simulation result of section stiffness of the multi-layered polymer sheet 100A corresponding to the first hard polymer film 11A of different thicknesses is shown in FIG. 4. As shown in FIG. 4, the thickness ratio of the first hard polymer film 11A in the multi-layered polymer sheet 100A can be tuned to adjust the section stiffness of the multi-layered polymer sheet 100A.

In some embodiments as shown in FIG. 2, the multi-layered polymer sheet 100B has a thickness of 0.5 mm to 1.0 mm, the first hard polymer film 11A and the second hard polymer film 11B have a total thickness of 0.4 mm to 0.9 mm, and the first soft polymer film 15A has a thickness of 0.01 mm to 0.4 mm. For example, the multi-layered polymer sheet 100B has a total thickness of 0.7 mm, and the first hard polymer film 11A and the second hard polymer film 11B have the same thickness. A simulation result of section stiffness of the multi-layered polymer sheet 100B corresponding to the first hard polymer film 11A and the second hard polymer 11B of different total thicknesses is shown in FIG. 5. As shown in FIG. 5, the thickness ratio of the first hard polymer film 11A and the second hard polymer film 11B in the multi-layered polymer sheet 100B can be tuned to adjust the section stiffness of the multi-layered polymer sheet 100B.

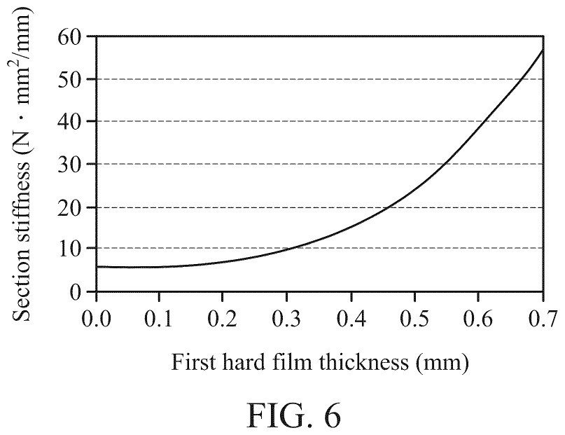

In some embodiments as shown in FIG. 3, the multi-layered polymer sheet 100C has a thickness of 0.5 mm to 1.0 mm, the first hard polymer film 11A has a thickness of 0.4 mm to 0.8 mm, and the first soft polymer film 15A and the second soft polymer film 15B have a total thickness of 0.1 mm to 0.4 mm. For example, the multi-layered polymer sheet 100C has a total thickness of 0.7 mm, and the first soft polymer film 15A and the second soft polymer film 15B have the same thickness. A simulation result of section stiffness of the multi-layered polymer sheet 100C corresponding to the first hard polymer film 11A of different total thicknesses is shown in FIG. 6. As shown in FIG. 6, the thickness ratio of the first hard polymer film 11A in the multi-layered polymer sheet 100C can be tuned to adjust the section stiffness of the multi-layered polymer sheet 100C.

If the thickness of the multi-layered polymer sheet 100A, 100B, and 100C is too low, the brace formed from it will be worn comfortable but apply a little force to move the teeth and the orthodontic effect will be poor. If the thickness of the multi-layered polymer sheet 100A, 100B, and 100C is too much, the brace formed from it will be worn uncomfortable and the brace will apply too much force to the teeth. If the thickness of the first hard polymer film 11A (and the second hard polymer film 11B, if existing) is too small, the brace formed from it will apply a little force to the teeth and the orthodontic effect will be poor. If the thickness of the first hard polymer film 11A (and the second hard polymer film 11B, if existing) is too large, the brace formed from it will be worn uncomfortable and the brace will apply too much force to move the teeth. If the thickness of the first soft polymer film 15A (and the second soft polymer film 15B, if existing) is too small, the brace formed from it will be worn uncomfortable. If the thickness of the first soft polymer film 15A (and the second soft polymer film 15B, if existing) is too large, the brace formed from it will apply a little force to move the teeth and the orthodontic effect will be poor

In some embodiments, the multi-layered polymer sheet has an elastic modulus of 800 MPa to 1500 MPa. If the elastic modulus of the multi-layered polymer sheet is too low, the brace formed from it will apply a small force to move the teeth, and the orthodontic effect will be poor. If the elastic modulus of the multi-layered polymer sheet is too large, the brace formed from it will be worn uncomfortable, and the brace will apply too much force to the teeth. In some embodiment, the multi-layered polymer sheet has a damping factor (tan δ) of 0.01 to 0.18. If the damping factor of the multi-layered polymer sheet is too low, the brace formed from it will be worn uncomfortable.

In some embodiments, the previously described multi-layered polymer sheet can be used to form a brace. The multi-layered polymer sheet can be heated and then molded by vacuum molding method to form the brace, which can be performed in such equipment as a professional brace molding machine MINISTARS® (commercially available from SCHEU). In addition, the multi-layered polymer sheet can be used in another transparent object for absorbing vibration and impact energy.

The multi-layered polymer sheet can be manufacture as small quantity and large variety production according to the requirements of the customer for achieving the customization purpose due to the properties of the material (e.g. soft polymer film of thermoset polymer) and the process (e.g. coating and then UV curing) of the multi-layered polymer sheet in the disclosure. In addition, the physical properties (e.g. section stiffness) of the multi-layered polymer sheet of the disclosure can be adjusted by only tuning the thickness ratio of the soft polymer film and the hard polymer film without changing the composition types of composition ratios in the soft polymer film, which may efficiently reduce the process complexity and related cost of manufacturing the multi-layered polymer sheet. For the customer, the products of small quantity and large variety can be ordered on the basis of requirement to improve the clinical quality without being limited by the commercially available products of a less specifications. Because the cost of the raw materials of the multi-layered polymer sheen is low and the process skill is simple, the related cost can be further lowered.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

1 part by weight of α-hydroxy ketone (173 commercially available from Double Bond Chemical, liquid state) serving as a photo initiator, 1.5 parts by weight of α-hydroxy ketone (184 commercially available from Double Bond Chemical, solid state) serving as a photo initiator, 60 parts by weight of aliphatic polyurethane diacrylate oligomer (5300 commercially available from Double Bond Chemical, having two acrylate groups) serving as an acrylate oligomer, 40 parts by weight of aliphatic polyurethane multi-acrylate oligomer (588 commercially available from Double Bond Chemical, having ten acrylate groups) serving as an acrylate oligomer, 20 parts by weight of ethoxylated pentaerythritol triacrylate (TMP(5E0)TA commercially available from Double Bond Chemical, having three acrylate groups) serving as a acrylate monomer, 1.5 parts by weight of adhesive promoter (9167 commercially available from Double Bond Chemical), and 2.5 parts by weight of leveling agent (9011 commercially available from Double Bond Chemical) were mixed to form a UV curable coating. The UV curable coating could be coated on a surface of a hard substrate, and then cured to measure its properties.

The UV curable coating was coated on a hard polymer film (PETG film commercially available from SK, copolymerized from terephthalic acid, cyclohexanedimethanol, and ethylene glycol), another hard polymer film (PETG film) was attached to the UV curable coating, and the UV curable coating was exposed to UV radiation to be cured and to form a soft polymer film disposed between the two hard polymer films. As such, a multi-layered polymer sheet was obtained.

The multi-layered polymer sheet had a thickness of 0.76 mm, each of the hard polymer films had a thickness of 0.34 mm, and the soft polymer film had a thickness of 0.08 mm. The hard polymer film had an elastic modulus (E′) of 1599 MPa (at 37° C., similar to oral temperature). The multi-layered polymer sheet had an elastic modulus of 1426 MPa (at 37° C., similar to oral temperature) and an elastic modulus of 948 MPa (at 60° C., similar to hot drink temperature). The elastic modulus and damping factor were measured by a dynamic mechanical analyzer (TAQ800 commercially available from TA). The test condition were listed below: single cantilever length: 17.5 cm; frequency: 1 Hz, amplitude: 60 μm; and temperature rise rate: 5° C./min. The storage modulus (E′) and damping factor (tan δ) of the multi-layered polymer sheet (at 37° C. and 60° C.) before and after being soaked in water for 2 weeks (336 hours) were measured, as tabulated in Table 1.

### Example 2

1 part by weight of α-hydroxy ketone (173 commercially available from Double Bond Chemical, liquid state) serving as a photo initiator, 1.5 parts by weight of α-hydroxy ketone (184 commercially available from Double Bond Chemical, solid state) serving as a photo initiator, 40 parts by weight of aliphatic polyurethane diacrylate oligomer (5300 commercially available from Double Bond Chemical, having two acrylate groups) serving as an acrylate oligomer, 40 parts by weight of aliphatic polyurethane multi-acrylate oligomer (588 commercially available from Double Bond Chemical, having ten acrylate groups) serving as an acrylate oligomer, 10 parts by weight of ethoxylated pentaerythritol triacrylate (TMP(5EO)TA commercially available from Double Bond Chemical, having three acrylate groups) serving as a acrylate monomer, 1.5 parts by weight of adhesive promoter (9167 commercially available from Double Bond Chemical), and 2.5 parts by weight of leveling agent (9011 commercially available from Double Bond Chemical) were mixed to form a UV curable coating. The UV curable coating could be coated on a surface of a hard substrate, and then cured to measure its properties.

The UV curable coating was coated on a hard polymer film (PETG film commercially available from SK, copolymerized from terephthalic acid, cyclohexanedimethanol, and ethylene glycol), another hard polymer film (PETG film) was attached to the UV curable coating, and the UV curable coating was exposed to UV radiation to be cured and to form a soft polymer film disposed between the two hard polymer films. As such, a multi-layered polymer sheet was obtained.

The multi-layered polymer sheet had a thickness of 0.76 mm, each of the hard polymer films had a thickness of 0.34 mm, and the soft polymer film had a thickness of 0.08 mm. The hard polymer film had an elastic modulus (E′) of 1599 MPa (at 37° C., similar to oral temperature). The multi-layered polymer sheet had an elastic modulus of 1464 MPa (at 37° C., similar to oral temperature) and an elastic modulus of 1218 MPa (at 60° C., similar to hot drink temperature). The elastic modulus and damping factor were measured by a dynamic mechanical analyzer (TAQ800 commercially available from TA). The test condition were listed below: single cantilever length: 17.5 cm; frequency: 1 Hz, amplitude: 60 μm; and temperature rise rate: 5° C./min. The storage modulus (E′) and damping factor (tan δ=E″/E′, wherein E″ is loss modulus) of the multi-layered polymer sheet (at 37° C. and 60° C.) before and after being soaked in water for 2 weeks (336 hours) were measured, as tabulated in Table 1.

In addition, the multi-layered polymer sheet in Example 2 passed the test of in vitro cytotoxicity under the standard ISO 10993-5. In short, the multi-layered polymer sheet in Example 2 could be safely used as an object for touching human body, such as a brace. Comparative Example 1

A three-layered polymer sheet (Zendura™ FLX commercially available from Bay Materials) having a total thickness of 0.76 mm was provided. The storage modulus (E′) and damping factor (tan δ=E″/E′, wherein E″ is loss modulus) of the multi-layered polymer sheet (at 37° C. and 60° C.) before and after being soaked in water for 2 weeks (336 hours) were measured, as tabulated in Table 1.

TABLE 1

| | Before soaking | | After soaking | | Before soaking | | After soaking | |
|---|---|---|---|---|---|---|---|---|
| | E′@37° C. | E′@60° C. | E′@37° C. | E′@60° C. | Tanδ@37° C. | Tanδ@60° C. | Tanδ@37° C. | Tanδ@60° C. |
| Example 1 | 1426 | 948.2 | 1304 | 868.7 | 0.1523 | 0.0866 | 0.1731 | 0.0878 |
| Example2 | 1464 | 1218 | 1473 | 1291 | 0.0326 | 0.0541 | 0.0315 | 0.0514 |
| Comparative | 1361 | 1245 | 1134 | 1043 | 0.0183 | 0.0179 | 0.0157 | 0.0163 |
| Example 1 | | | | | | | | |

As shown in Table 1, the multi-layered polymer sheets of Examples in the disclosure had higher damping factors that that of the commercially available product. When the multi-layered polymer sheets of Examples were used to manufacture a brace, which could mitigate the discomfort of the orthodontic patients. In addition, the multi-layered polymer sheet of Examples in the disclosure had a higher elastic modulus than that of the commercially available product. When the multi-layered polymer sheets of Examples were used to manufacture a brace, which could apply a higher stress to efficiently move the teeth of the orthodontic patients. In general, the brace material having a higher elastic modulus could apply a higher stress to the teeth, but it also increased the discomfort of the orthodontic patients. However, the multi-layered polymer sheet of Examples in the disclosure simultaneously had the high elastic modulus and the high damping factor, which had double advantages such as efficiently moving the teeth and mitigating the discomfort of the orthodontic patients.

### Example 3

The multi-layered polymer sheet in Comparative Example 1 was tested by a tensile testing machine according to the standard ASTMD790 to measure its yield stress (45.15 MPa), yield load point displacement (2.879 mm), ¼ yield load point displacement (0.73 mm), and sample size (50 mm*25.8 mm*0.77 mm). Similarly, the multi-layered polymer sheet in Example 2 was tested according to the standard ASTMD790 to measure its yield stress (43.42 MPa), yield load point displacement (2.708 mm), ¼ yield load point displacement (0.69 mm), and sample size (50 mm*27.4 mm*0.76 mm).

The commercially available polymer sheets and the multi-layered polymer sheet in Example 2 were soaked in water at 37° C. for 24 hours, and ¼ yield load point displacement of the polymer sheets was kept in water at 37° C. for 24 hours by the tensile testing machine to monitor their stress relaxation degrees, as tabulated in Table 2.

TABLE 2
(Stress relaxation after 24 hours, %)

| | |
|---|---|
| Commercially available product F22 Aligner (Sweden | 54.5% |
| & Martina, Due Carrare, Padova, Italy) | |
| Commercially available product Duran (SCHEU, | 62% |
| Iserlohn, Germany) | |
| Commercially available product Erkoloc-Pro | 25.5% |
| (Erkodent, Pfalzgrafenweiler, Germany) | |
| Commercially available product Durasoft (SCHEU) | 17.9% |
| Comparative Example 1 (Commercially available | 16.6% |
| product Bay Material Zendura ™ FLX) | |
| Example 2 | 17.5% |

In general, the higher stress relaxation degree means the stress applied by an object (e.g. the brace) after being used for a period would be lower. As shown in Table 2, the stress relaxation degree of the multi-layered polymer sheet of Example 2 in the disclosure was close to the best stress relaxation degree of the commercially available products.

### Example 4

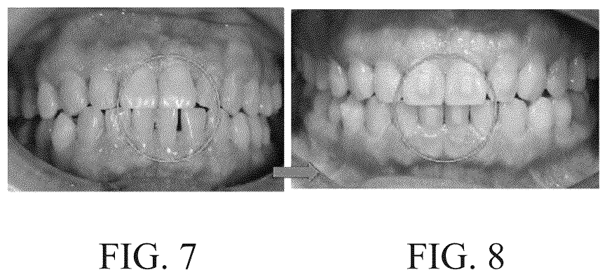

The multi-layered polymer sheet prepared in Example 2 was used to manufacture braces in practice. The orthodontist could use the braces to straighten the teeth of the orthodontic patients. FIG. 7 shows a photograph of the teeth before being straightened, and FIG. 8 shows a photograph of the teeth after being straightened. The straightened teeth were obviously more even. Accordingly, the multi-layered polymer sheets of Examples in the disclosure were practically effective in clinical application. It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A multi-layered polymer sheet, comprising:
a first hard polymer film with an elastic modulus of 1000 MPa to 2500 MPa; and
a first soft polymer film with an elastic modulus of 100 MPa to 1000 MPa disposed on the first hard polymer film,
wherein the elastic modulus of the first hard polymer film is greater than that of the first soft polymer film by at least 500 MPa,
wherein the first hard polymer film includes a thermoplastic polymer, and the first soft polymer film includes a thermoset polymer.

2. The multi-layered polymer sheet as claimed in claim 1, wherein the multi-layered polymer sheet has a thickness of 0.5 mm to 1.0 mm, the first hard polymer film has a thickness of 0.3 mm to 0.8 mm, and the first soft polymer film has a thickness of 0.1 mm to 0.4 mm.

3. The multi-layered polymer sheet as claimed in claim 1, further comprising a second hard polymer film, wherein the first soft polymer film is disposed between the first hard polymer film and the second hard polymer film, and a thickness and a composition of the first hard polymer film are substantially the same as that of the second hard polymer film.

4. The multi-layered polymer sheet as claimed in claim 3, wherein the multi-layered polymer sheet has a thickness of 0.5 mm to 1.0 mm, the first hard polymer film and the second hard polymer film have a total thickness of 0.4 mm to 0.9 mm, and the first soft polymer film has a thickness of 0.01 mm to 0.4 mm.

5. The multi-layered polymer sheet as claimed in claim 1, further comprising a second soft polymer film, wherein the first hard polymer film is disposed between the first soft polymer film and the second soft polymer film, and a thickness and a composition of the first soft polymer film are substantially the same as that of the second soft polymer film.

6. The multi-layered polymer sheet as claimed in claim 5, wherein the multi-layered polymer sheet has a thickness of 0.5 mm to 1.0 mm, the first hard polymer film has a thickness of 0.4 mm to 0.8 mm, and the first soft polymer film and the second soft polymer film have a total thickness of 0.1 mm to 0.4 mm.

7. The multi-layered polymer sheet as claimed in claim 1, wherein the thermoplastic polymer comprises polyester, polycarbonate, polyurethane, polyamide, polyolefin, polyether ether ketone, polyether sulfone, or a copolymer thereof.

8. The multi-layered polymer sheet as claimed in claim 1, wherein the thermoset polymer is made of a UV curable coating cured by UV radiation, and the UV curable coating comprises a photo initiator, an acrylate oligomer, and an acrylate monomer.

9. The multi-layered polymer sheet as claimed in claim 8, wherein the acrylate oligomer comprises aliphatic polyurethane diacrylate oligomer, aromatic polyurethane diacrylate oligomer, aliphatic polyurethane multi-acrylate oligomer, aromatic polyurethane multi-acrylate oligomer, or a combination thereof, and the acrylate monomer comprises aliphatic tri-functional methacrylate, bisphenol A epoxy acrylate, aliphatic trifunctional acrylate, urethane dimethacrylate, or a combination thereof.

10. The multi-layered polymer sheet as claimed in claim 1, wherein the multi-layered polymer sheet has an elastic modulus of 800 MPa to 2000 MPa.

11. The multi-layered polymer sheet as claimed in claim 1, wherein the multi-layered polymer sheet has a damping factor (tan δ) of 0.01 to 0.18.

12. A brace, being formed from the multi-layered polymer sheet as claimed in claim 1.

13. A method of forming a multi-layered polymer sheet, comprising:
providing a first hard polymer film with an elastic modulus of 1000 MPa to 2500 MPa;
coating a UV curable coating on a first surface of the first hard polymer film; and
exposing the UV curable coating to UV radiation to cure the UV curable coating, thereby forming a first soft polymer film on the first surface of the first hard polymer film, wherein the first soft polymer film has an elastic modulus of 100 MPa to 1000 MPa,
wherein the elastic modulus of the first hard polymer film is greater than that of the first soft polymer film by at least 500 MPa,
wherein the first hard polymer film includes a thermoplastic polymer, the first soft polymer film includes a thermoset polymer, and the UV curable coating comprises a photo initiator, an acrylate oligomer, and an acrylate monomer.

14. The method as claimed in claim 13, wherein the acrylate oligomer comprises aliphatic polyurethane diacrylate oligomer, aromatic polyurethane diacrylate oligomer, aliphatic polyurethane multi-acrylate oligomer, aromatic polyurethane multi-acrylate oligomer, or a combination thereof, and the acrylate monomer comprises aliphatic tri-functional methacrylate, bisphenol A epoxy acrylate, aliphatic trifunctional acrylate, urethane dimethacrylate, or a combination thereof.

15. The method as claimed in claim 13, further comprising:
attaching a second hard polymer film onto the UV curable coating after coating the UV curable coating on the first surface of the first hard polymer film and before curing the UV curable coating, and then exposing the UV curable coating to UV radiation to cure the UV curable coating, thereby forming the first soft polymer film between the first hard polymer film and the second hard polymer film, wherein a composition of the first hard polymer film is substantially the same as that of the second hard polymer film.

16. The method as claimed in claim 13, further comprising:
coating another UV curable coating on a second surface of the first hard polymer film after forming the first soft polymer film on the first surface of the first hard polymer film, and the second surface of the first hard polymer film is opposite the first surface of the first hard polymer film; and
exposing the other UV curable coating to UV radiation to cure the other UV curable coating, thereby forming a second soft polymer film on the second surface of the first hard polymer film, wherein a composition of the first soft polymer film is substantially the same as that of the second soft polymer film.
